(19) United States
(12) Patent Application Publication
(10) Pub. No.: US 2024/0052686 A1
(43) Pub. Date: Feb. 15, 2024

(54) RETRACTABLE HOUSING ASSEMBLY

(71) Applicant: Jason Augustin Korda, Red Hill (AU)

(72) Inventor: Jason Augustin KORDA, Red Hill (AU)

(21) Appl. No.: 18/267,954

(22) PCT Filed: Dec. 20, 2021
(86) PCT No.: PCT/AU2021/051525

§ 371 Date: Jun. 16, 2023

(30) Foreign Application Priority Data
Dec. 18, 2020 (AU) 2020104179

(51) Int. Cl. E05G 7/00; A47B 46/00

(52) U.S. Cl. CPC E05G 7/00; A47B 46/00

(57) ABSTRACT

The present invention relates to a retractable housing assembly for a payment device comprising a housing defining an internal volume, a frame connected to the housing, a carriage operatively connected to the frame, wherein the carriage is adapted to receive a payment device, wherein the carriage is in slidable engagement with the frame. The present invention alleviates one or more issues associated with tampering, vandalism and/or robberies.

### FIELD OF THE INVENTION

The present invention relates to the field of payments. More particularly, the invention relates to a retractable housing assembly. Even more particularly, the invention relates to a retractable housing assembly for a payment device.

### BACKGROUND TO THE INVENTION

Any reference to background art herein is not to be construed as an admission that such art constitutes common general knowledge in Australia or elsewhere.

Contactless payment and card payment techniques have become an integral part of everyday transactions. As such, electronic funds transfer at point of sale (EFTPOS) machines are present at many counters for payment.

However, robberies, vandalism and tampering is still a major issue with EFTPOS machines. In this regard, vandals may target an unmanned EFTPOS machine or unmanned EFTPOS machines may be tampered with to ‘skim’ card details. Furthermore, in situations where few citizens are present (e.g., petrol station late at night), opportunistic robberies may occur.

Typically, EFTPOS machines are located at counters in which physical tender is kept. Minimizing contact between the customer and the counter/staff is one solution to the issue of robberies. In this regard, one option is to provide an EFTPOS machine remote from the counter or staff. However, these ETFPOS machines may be vandalized, or tampered with, when located remotely.

It would be useful to address one or more of the above issues and/or provide the consumer with a commercial alternative.

### SUMMARY OF THE INVENTION

In one aspect, although it need not be the only or indeed the broadest aspect, the invention resides in a retractable housing assembly for a payment device comprising:
a housing defining an internal volume;
a frame connected to the housing;
a carriage operatively connected to the frame, wherein the carriage is adapted to receive a payment device, wherein the carriage is in slidable engagement with the frame.

In an embodiment, the retractable housing further comprises an actuator. The actuator is suitably configured to slide the carriage between a retracted position and an extended position. In one embodiment, the actuator comprises a stepper motor and a motor driver. In some embodiments, the actuator further comprises a cooling fan.

In embodiments, the housing comprises a base connected to a first wall and a second wall, and a top connected to the first wall and the second wall. The housing further comprises a front wall and/or a rear wall. In one embodiment, the front wall is suitably hingedly connected to one of the first wall, the second wall, base or top. The second wall is suitably hingedly connected to one of the first wall, the second wall, base or top.

In one embodiment, the front wall is connected to the first wall, the second wall, the top and base. In this embodiment, an openable wall may be formed on one of the first wall, second wall, top or base. The openable wall may comprise a first openable wall and a second openable wall.

In some embodiments, the frame is fastened with the base. In some embodiments, the frame comprises one or more rails. Suitably, the one or more rails are fastened to the base.

In one embodiment, the retracted position comprises a front end of the carriage being substantially coextensive with a front of the frame. In an embodiment, the extended position comprises the front end of the carriage being cantilevered beyond the front end of the frame.

In certain embodiments, the payment device is rotatable relative to the carriage.

In some embodiments, the front wall is connected to the carriage such that the front wall is opened when the carriage is in the extended position.

In one embodiment, the front wall comprises a first front wall and a second front wall. The first front wall is actuated by a first actuator and the second front wall is actuated by a second actuator.

In some embodiments, the first actuator is connected to the first front wall by a first hinge assembly. In an embodiment, the second actuator is connected to the second front wall by a second hinge assembly.

In an embodiment, the first hinge assembly comprises a first bracket fixedly secured to the first front wall, a second bracket fixedly secured to the housing, wherein the first bracket and second bracket are connected by a first connecting member and a second connecting member.

In one embodiment, the first connecting member is an elongate member. In an embodiment, the second connecting member comprises a body that comprises a bend. In a further embodiment, the body comprises an extension extending away from the body.

In some embodiments, the second hinge assembly comprises a first bracket fixedly secured to the first front wall, a second bracket fixedly secured to the housing, wherein the first bracket and the second bracket are connected by three connecting members.

In embodiments, the rear wall comprises a lock.

In embodiment, the retractable housing assembly further comprises an infrared sensor.

In one embodiment, the housing is formed of aluminium. In one embodiment, the aluminium is marine grade aluminium. In embodiments, the aluminium has a thickness of at least about 1 mm, at least about 5 mm, between about 5 mm and about 10 mm, between about 6 mm and about 8 mm, or about 7 mm.

In a second aspect, the invention resides in a method of providing access to a payment device including the steps of:
providing retractable housing assembly for a payment device comprising a housing defining an internal volume, a frame connected to the housing, a carriage operatively connected to the frame, wherein the carriage is adapted to receive a payment device, wherein the carriage is in slidable engagement with the frame; and
sliding the carriage relative to the frame;
to provide access to the payment device.

The retractable housing assembly and components thereof are as substantially described herein

In one embodiment, the method, further includes the step of retracting the carriage relative to the frame.

The various features and embodiments of the present invention referred to in the individual sections above and in the description which follows apply, as appropriate, to other sections, mutatis mutandis. Consequently features specified in one section may be combined with features specified in other sections as appropriate.

Further features and advantages of the present invention will become apparent from the following detailed description.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, in which:

FIG. 1 shows a perspective view of a retractable housing assembly;

FIG. 2 shows a side view of the retractable housing assembly of FIG. 1;

FIG. 3 shows a top view of the retractable housing assembly of FIG. 1;

FIG. 4 shows an exploded view of the retractable housing assembly of FIG. 1 without the housing;

FIG. 5 shows the retractable housing assembly of FIG. 1 with the first wall, second wall and top omitted;

FIG. 6a shows the retractable housing assembly of FIG. 1 in the extended position in a wall;

FIG. 6b shows the retractable housing assembly of FIG. 6a in the retracted position in a wall;

FIG. 7a shows another embodiment of the retractable housing assembly in an extended position;

FIG. 7b shows the retractable housing assembly of FIG. 7a in a retracted position;

FIG. 8 shows the retractable housing assembly of FIG. 7a in a retracted position with the first and second hinge assemblies shown in expanded view; and

FIG. 9a shows another embodiment of the retractable housing 300 in the retracted position; and

FIG. 9b shows the retractable housing of claim 9a in the extended position.

### DETAILED DESCRIPTION OF THE INVENTION

Embodiments of the present invention reside primarily in a retractable housing assembly. Accordingly, the assembly and method steps have been illustrated in concise schematic form in the drawings, showing only those specific details that are necessary for understanding the embodiments of the present invention so as to not obscure the disclosure with excessive detail that will be readily apparent to those of ordinary skill in the art having the benefit of the present description.

In this specification, adjectives such as first and second, top and bottom, and the like may be used solely to distinguish one element or action from another element or action without necessarily requiring or implying any actual such relationship or order.

Words such as “comprises” or “includes” are intended to define a non-exclusive inclusion, such that a process, method, article, or apparatus that comprises a list of elements does not include only those elements but may include other elements not expressly listed, including elements that are inherent to such a process, method, article, or apparatus.

As used herein, the term ‘about’ means the amount is nominally the number following the term ‘about’ but the actual amount may vary from this precise number to an unimportant degree.

The present invention is predicated on the finding that providing a retractable housing assembly for a payment device can alleviate one or more of the abovementioned issues. In this regard, the retractable housing assembly provides protection for the payment device and also allows them to be operated remotely or automatically. For ease of description, the present invention has been described as being automatically operable; however, the person skilled in the art will appreciate that the present invention may also be manually operable (that is, operated remotely by an operator).

In a first aspect, although it need not be the broadest or indeed the only aspect, the invention resides in a retractable housing assembly for a payment device comprising
a housing defining an internal volume;
a frame connected to the housing;
a carriage operatively connected to the frame, wherein the carriage is adapted to receive a payment device, wherein the carriage is in slidable engagement with the frame.

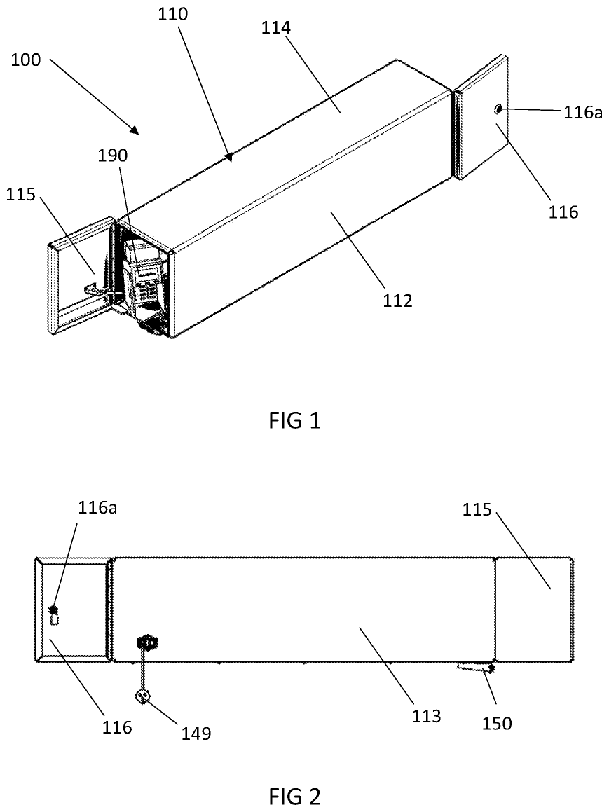

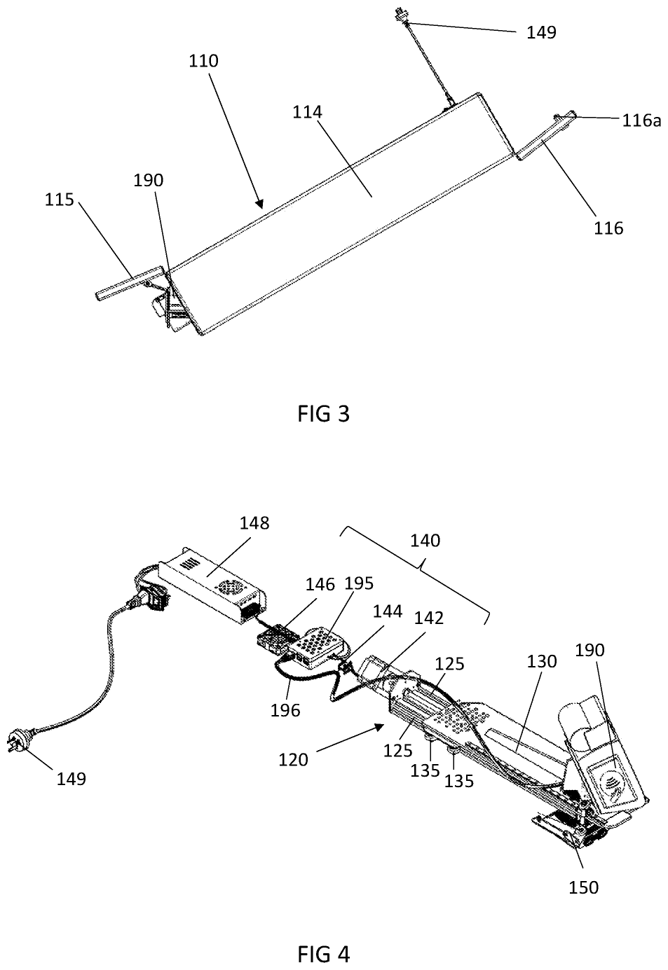

Shown in FIGS. 1-5 is an embodiment of a retractable housing assembly 100. Retractable housing assembly 100 comprises a housing 110. The housing 110 comprises a base 111 connected to a first wall 112 and a second wall 113, and a top 114 connected to the first wall 112 and the second wall 113. The housing 100 further comprises a front wall 115 and a rear wall 116. The front wall 115 may be hingedly attached to an end of one of the base 111, first wall 112, second wall 113 or top 114. The rear wall 115 may be hingedly connected to the other end of the base 111, first wall 112, second wall 113 or top 114 (that is, the opposing end in which the front wall 115 is attached). The front wall 115 and rear wall 116 allow access to the internal volume defined by the housing 110. That is, the front wall 115 and rear wall 116 may be opened to allow access to the internal volume of the housing 110.

The person skilled in the art will appreciate that any hinge can be utilized to connect the front wall 115 and the rear wall 116 to one of the base 111, first wall 112, second wall 113 or top 114. A non-limiting example of a hinge is a piano hinge.

The retractable housing assembly 100 further comprises a frame 120 connected to the housing 110. The frame 120 suitably comprises one or more rails 125. The frame 120 is fastened with the housing 110. The frame 120 is preferably fastened with the base 111.

The retractable housing assembly 100 further comprises a carriage 130. The carriage 130 is adapted to receive a payment device 190. The carriage 130 is slidable relative to the frame 120. The carriage 130 is preferably slidable relative to the one or more rails 125. That is, the carriage 130 is slidably connected to the one or more rails 125.

The carriage 130 may further comprise a first connection portion adapted to receive the payment device 190. In this regard, the payment device 190 comprises a reciprocal connection portion that is reciprocal to the first connecting portion. The first and second connection portion may suitably be configured to be rotatable relative to one another. In this regard, the attached payment device 190 is rotatable relative to the carriage 130. The person skilled in the art will appreciate that the payment device may be removable from the carriage for servicing requirements.

As shown in the figures, the slidable engagement of the carriage 130 to the frame 120 is suitably facilitated by a plurality of wheels 135 that slidably engage the one or more rails 125 or the frame 120. Preferably, the carriage 130 comprises the plurality of wheels 135. The person skilled in the art will appreciate that a number of different methods can be utilized to achieve this slidability.

The person skilled in the art will appreciate that the retractable housing assembly allows a payment device to be stored within the housing when not in use, and this protects it from vandalism, tampering and/or theft. The retractable housing assembly only allows access to the payment device when required. In this situation, the retractable housing assembly is configured to be in an extended position, and the consumer then has access to the payment device. The rotatability of the payment device relative to the carriage allows the consumer to manipulate the orientation of the payment device to their convenience.

The retractable housing assembly 100 may be configured between a retracted position and an extended position. The retracted position comprises a front end of the carriage 130 being substantially coextensive with a front of the frame 120. That is, in the retract position, the payment device 190 is within the internal volume of the housing 110. The extended position comprises the front end of the carriage 130 being cantilevered beyond the front end of the frame 120.

The retractable housing assembly 100 may further comprise an actuator 140. The actuator 140 is configured to slide the carriage 130 between the retracted position and the extended position. In one embodiment, the actuator 140 comprises a stepper motor 142 and a motor driver 144. In some embodiments, the actuator comprises a cooling fan 146. The actuator 140 and components thereof are suitably in electrical communication with a power supply 148. The actuator 140 comprises a micro control which may be utilized to actuate the retractable housing assembly 100 into the retracted position or the extended position. In the embodiment shown, the power supply 148 is connected to mains power via a power cable 149.

The actuator 140 is suitably a linear actuator. In one embodiment, the actuator 140 is a screw type actuator driven by the stepper motor 142. As the actuator 140 is actuated, it drives the carriage 130 such that the carriage 130 is cantilevered. The person skilled in the art will appreciate that the actuator 140 can push the carriage 130 such that it is in the extended position and also pull the carriage 130 such that is in the retracted position.

In the event that an individual attempts to vandalise, damage or tamper with the payment device 190 during payment, the operator may configure the retractable housing assembly 100 to be in the retracted position. This pulls the payment device 190 back into the housing 110 and protects it from further vandalism and/or damage.

In one embodiment, the retractable housing assembly 100 may further comprise an infrared sensor 150. The infrared sensor 150 is adapted to detect motion. The infrared sensor 150 is suitably adapted to detect a person, and actuate the retractable housing assembly 100 to be in the extended position such that the person can access the payment device. Alternatively, the person skilled in the art will appreciate that the retractable housing assembly 100 can be remotely operated by an operator who can actuate the actuator such that the retractable housing assembly 100 is in either the extended position or the retracted position. The actuator 140 and/or payment device 190 may suitably be in wired communication with a control unit or in wireless communication with a control unit. In the embodiment shown, the payment device 190 is in wired communication with a micro controller 195 via cable 196. The micro control 195 is suitably in wireless communication with the control unit (not shown, which may be operated by an operator).

In one embodiment, the front wall 115 is connected to the carriage 130. Suitably, the front wall 115 is connected to the carriage 130 at a front end thereof. Suitably, the front wall 115 is connected to the carriage 130 by a ball joint. The connection between the front wall 115 and the carriage 130 facilitates opening of the front wall 115 when the retractable housing assembly 100 is in the extended position and closes the front wall 115 when the retractable housing assembly 100 is in the retracted position. In the embodiment shown, the front wall 115 comprises a door connection bracket 115a connected to an arm 115c via a ball joint 115b. The arm 115c is connected at a distal end thereof to a guide rail 130a. The carriage 130 comprises the guide rail 130a.

In an embodiment, the rear wall comprises a lock 116a. The lock 116a prevents unauthorized access to the internal volume of the housing 110. The lock 116a engages a reciprocal locking member (not shown) to prevent unauthorized access to the internal volume of the housing 110.

In one embodiment, the housing 110 is formed of aluminium. In a preferred embodiment, the housing is formed of marine grade aluminium. In a more preferred embodiment, the housing is formed with a thickness of at least about 1 mm, at least about 5 mm, between about 5 mm to about 10 mm, between about 6 mm to about 8 mm, or about 7 mm. It will be appreciated that the body may be formed of any material that is able to protect the contents thereof, and these are known to the person skilled in the art.

In the embodiment shown, the housing 110 is in the form of a rectangular prism defined by the base 111, first wall 112, second wall 113, top 114, front wall 115 and rear wall 116. The front wall 115 and rear wall 116 define a front entry and a rear entry, respectively. The front entry and rear entry define a longitudinal axis. The one or more rails 125 of the frame 120 are fastened with the base 111 in parallel with the longitudinal axis. The carriage 130 is slidable relative to the one or more rails 125 of the frame 120. As such, the carriage 130 is slidable parallel to the longitudinal axis. The person skilled in the art will appreciate that the dimensions and orientation of the housing can be adapted for particular situations (mentioned in more detail hereinafter).

In use, the housing 110 may be formed in a structure such that it is protected from being damaged. For instance, the housing 110 may be formed in an external wall such that the front wall is accessible from the exterior. In this regard, when a consumer requires access to the payment device, the retractable housing assembly may be actuated to be in the extended position such that the consumer can utilize the payment device. The retractable housing may then be actuated to be in the retracted position such that the payment device is protected. Alternatively, the retractable housing may be attached to a structure such that it cannot be easily removed.

The rear wall may be opened such that an operator can access the internal volume of the retractable housing assembly. In this regard, the rear wall of the housing may be formed such that it is accessible from the inside of the structure. This advantageously allows an operator to access the contents thereof without having to go outside. This offers a further form of protection for the operator.

In an embodiment, the retractable housing may be secured relative to the ground. In this regard, the retractable housing may be secured to a body that is secured to the ground. For instance, the retractable housing may be secured to an elongate member (such as a pole) that is anchored to the ground. It will be appreciated that the retractable housing and secured body are secured to the ground and is very difficult to remove. This allows for the retractable housing to be provided in essentially any area required.

In one embodiment, the payment device is an EFTPOS machine.

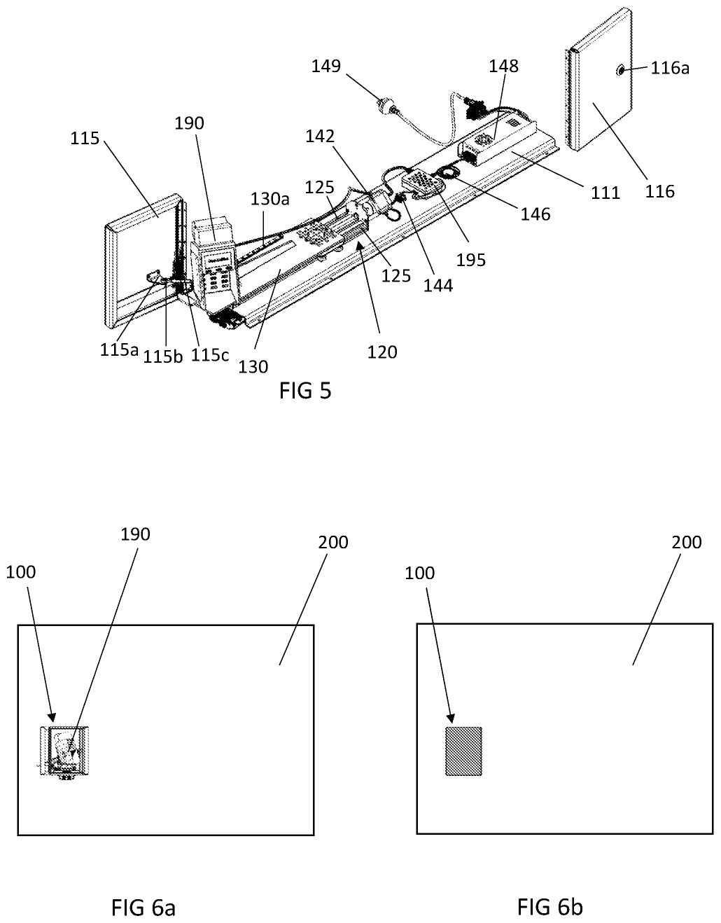

Shown in FIG. 6a is the retractable housing assembly 100 in a wall 200. The retractable housing assembly 100 is in the extended configuration, and the payment device 190 is accessible to the customer. In this regard, the carriage 130 is cantivered and the payment device 190 protrudes from the plane of the wall 200.

Shown in FIG. 6b is the retractable housing assembly 100 in the wall 200. However, in this figure, the retractable housing assembly 100 is in the retracted configuration. As shown, the payment device 190 is inaccessible to the customer and thus protected from vandalism, theft and tampering.

It should be appreciated that the present retractable housing assembly can be utilized in a number of different environments. In this regard, one of the environments of use is in a petrol station, whereby the retractable housing assembly is provided near or adjacent a petrol pump so that a motorist refuelling can attend to the payment of their petrol without needing to go to the counter. In this regard, the retractable housing assembly may further comprise a vehicle sensor. The vehicle sensor is adapted to detect the presence of a vehicle, and can also actuate the retractable housing assembly accordingly. It will be appreciated that the retractable housing assembly may be utilized in other environments.

However, the person skilled in the art will appreciate that the retractable housing assembly may be utilized in other environments such as but not limited to drive through payment and coffee shops.

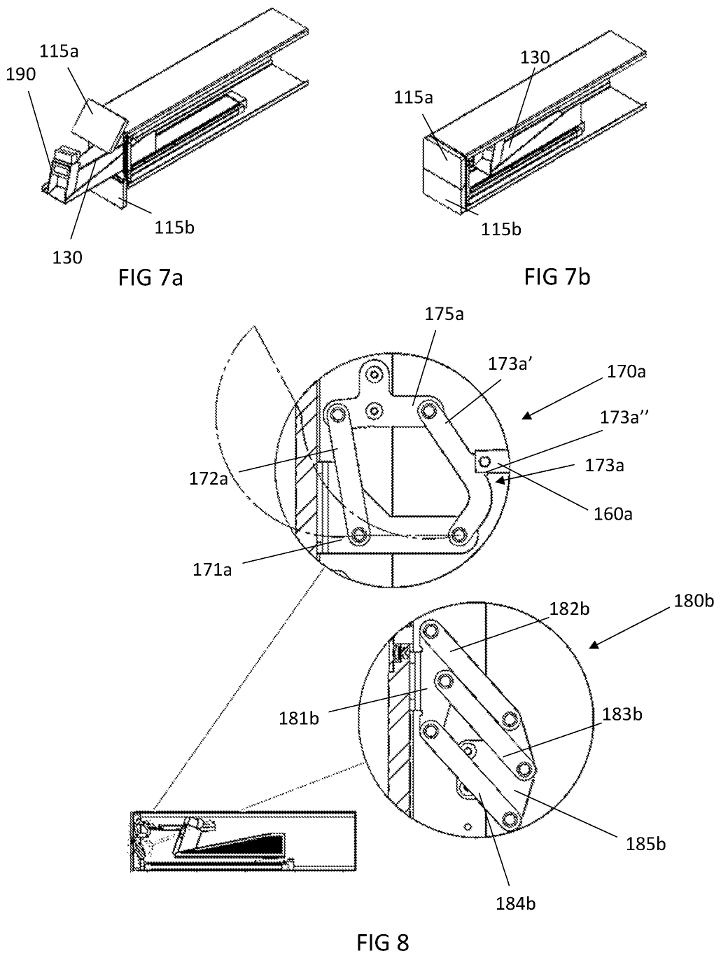

Shown in FIGS. 7a, 7b and 8 are an embodiment of the retractable housing assembly 100. This embodiment is substantially similar to the embodiment discussed hereinabove, with the exception that the front wall 115 is different. In this embodiment, the front wall 115 is formed of a first front wall 115a and a second front wall 115b.

In the embodiment shown, the first front wall 115a and the second front wall 115b are independently actuated. The first front wall 115a may be actuated by a first actuator 160a, and the second front wall 115b may be actuated by a second actuator 160b. However, it will be appreciated that the first front wall 115a and the second front wall 115b may be actuated by a common actuator. The first actuator 160a and the second actuator 160b are suitably connected and/or attached to the housing 110. The first actuator 160a and the second actuator 160b are suitably in electrical communication with the control unit. The control unit suitably controls the actuators. In a preferred embodiment, the first actuator 160a and the second actuator 160b are connected to an internal wall of the housing 110. In the embodiment shown, the first actuator 160a is connected to the first front wall 115a by a first hinge assembly 170a. In an embodiment, the second actuator 160b is connected to the second front wall 115b by a second hinge assembly 180b. In some embodiments, the first actuator 160a may comprise an extension member for attaching to the first hinge assembly 170a. In embodiments, the second actuator 160b may comprise an extension member for attaching to the second hinge assembly 180. The extension member allows for the actuator to be placed in a more appropriate position in relation to the carriage.

The person skilled in the art will appreciate that, in the retracted position, the front wall 115 does not allow access to the internal volume of the housing 110; and that, in the extended position, the front wall 115 allows access to the internal volume of the housing 110. In the present embodiment, the first front wall 115a and the second front wall 115b are configured to meet when the carriage is in the retracted position and extends away from each other when the carriage is in the extended position. This allows for the carriage and payment device to extend from the assembly and be accessible to a consumer.

Referring to FIG. 8, there is shown an enlarged view of the first hinge assembly 170a in the retracted position. The first hinge assembly 170a comprises a first bracket 171a fixedly secured to the first front wall 115a. The first hinge assembly 170a further comprises a second bracket 175a fixedly secured to the housing 110. The first bracket 171a comprises a pair of spaced apart apertures. The second bracket 175a comprises a pair of second spaced apart apertures. The pair of spaced apart apertures and pair or second spaced apart apertures are adapted to receive a first connecting member 172a and a second connecting member 173a, respectively.

In the embodiment shown, the first connecting member 172 comprises a substantially straight elongate member that is pivotably connected to one of the pair of spaced apart apertures and one of the pair of second spaced apart apertures at ends thereof.

The second connecting member 173a comprises a body 173a′. The body 173a′ is pivotably connected to the other of the pair of spaced apart apertures and the other of the pair of second spaced apart apertures. In one embodiment, the body 173a′ comprises a bend therein. The body 173a′ further comprises an extension 173a″ that comprises an aperture adapted to pivotably connect to the first actuator 160a. As the first actuator 160a is actuated, the first front wall 115a is angled to allow the carriage and payment device a passage way out of the internal volume. Shown in the dotted lines is the pathway of the first front wall 115a when the first actuator 160a is actuated.

Also shown in FIG. 8 is an enlarged view of the second hinge assembly 180b in the retracted position. The second hinge assembly 180b comprises a first bracket 181b fixedly secured to the second front wall 115b. The second hinge assembly 180b comprises a second bracket 185b fixedly secured to the housing 110. The first bracket 181b comprises three spaced apart apertures. The second bracket 185b comprises three spaced apart apertures. As shown, one of the three apertures is offset. Each spaced apart apertures of the first bracket 181b and a complementary aperture of the second bracket 185b are adapted to receive a respective member 182b, 183b, 184b. Each of the members 182b, 183b, 184b is an elongate member. Each member 182b, 183b, 184b is pivotably connected to the first bracket 181b and second bracket 185b at ends thereof. The second bracket 185 further comprises an aperture (not shown) adapted to pivotably connect to the second actuator 160b. As the second actuator 160b is actuated, the second front wall 115b is opened parallel to allow the carriage and payment device out of the internal volume.

It will be appreciated that the no external fittings are required in this set up and this ameliorates the problem of tampering. As there are no external fittings, this embodiment is more secure.

In one embodiment, the front wall 115 may further comprise a frame. The frame may be adapted to provide a recess to accommodate the first front wall 115a and second front wall 115b. This not only provides an aesthetically pleasing appearance, but also alleviates the issue of the doors being pried open. The recess may also prevent water ingress into the internal volume.

In one embodiment, the first front wall may be connected to the housing via the second hinge assembly mentioned hereinabove. In a further embodiment, the second front wall may be connected to the housing via the second hinge assembly mentioned hereinabove. It will be appreciated that in this embodiment, both the first front wall and second front wall are connected to the housing via the second hinge assembly.

In another embodiment, the first front wall may be connected to the housing via the first hinge assembly mentioned hereinabove. In a further embodiment, the second front wall may be connected to the housing via the first hinge assembly mentioned hereinabove. It will be appreciated that in this embodiment, both the first front wall and second front wall are connected to the housing via the first hinge assembly.

It will be appreciated that the housing is suitably can be suitably formed of any dimensions. In this regard, the retractable housing shown in FIGS. 1 to 5 is in the form of a rectangular prism. The rectangular prism shape may be particularly suitable for being formed in a wall.

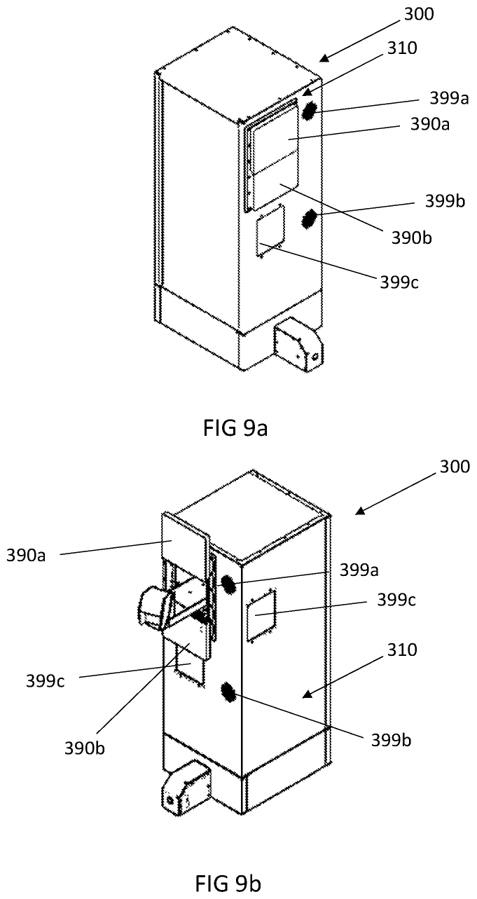

However, shown in FIGS. 9a and 9b are an embodiment of a retractable housing 300 that is in the form a vertical rectangular prism shape. FIG. 9a shows the retractable housing 300 in the retracted position, and FIG. 9b shows the retractable housing in the extended position. The retractable housing 300 is as substantially described hereinabove. For the sake of brevity, the description in relation to retractable house 100 is applicable to retractable house 200.

However, in contrast to the retractable housing 100 shown in FIGS. 1 to 5, retractable house 300 is oriented upright such that the carriage extends from a longer side of the retractable housing. It is contemplated that this embodiment is particularly useful when secured to a pole that is anchored to the ground. As shown, a first openable wall 390a and a second openable wall 390b are formed on a wall of a housing 310.

Similar to the above first front wall 115a and the second front wall 115b, the first openable wall 390a and the second openable wall 390b can be actuated such that the retractable housing assembly 300 is in the retracted position and the extended position.

In some embodiments, the base of the retractable housing 300 comprises a fixing portion (not shown). The fixing portion is suitably adapted to be affixed to a body that is secured to the ground. In one embodiment, the body is a pole.

It will be appreciated that, although the present embodiment has been described with one hinge assembly for the first front wall and a different hinge assembly for the second front wall, the same of different hinge assemblies may be utilized for the first front wall and the second front wall.

It will be appreciated that the retractable housing may further comprise additional components. In one embodiment, the retractable housing comprises a microphone and/or a speaker. In the embodiment shown, the retractable housing comprises a microphone 399a. In the embodiment shown, the retractable housing comprises a speaker 399b. The microphone and/or speaker are suitably in communication an operator and allows a consumer to communicate with an operator who is located away from the retractable housing.

The retractable housing may further include a light source. In one embodiment, the retractable housing further comprises a light source. In one embodiment, the light source is an illumination panel or a light. In the embodiment shown, the retractable housing comprises an illumination panels 399c. The illumination panel or light source provides the consumer with a source of light to alleviate the issues with low light scenarios. The light source assists in illuminating the payment device. It will be appreciated by the person skilled in the art that the above list of light sources only represents a few examples of the light source, and that other light sources known in the art may be utilized with the present invention.

In a second aspect, the invention resides in a method of providing access to a payment device including the steps of:
providing retractable housing assembly for a payment device comprising a housing defining an internal volume, a frame connected to the housing, a carriage operatively connected to the frame, wherein the carriage is adapted to receive a payment device, wherein the carriage is in slidable engagement with the frame; and
sliding the carriage relative to the frame;
to provide access to the payment device.

The retractable housing assembly and components thereof may be as substantially described herein for the first aspect.

In one embodiment, the method further includes the step of retracting the carriage relate to the frame.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. A retractable housing assembly for a payment device comprising:
a housing defining an internal volume;
a frame connected to the housing;
a carriage operatively connected to the frame, wherein the carriage is adapted to receive a payment device, wherein the carriage is in slidable engagement with the frame; and
to provide access to the payment device.

2. A method of providing access to a payment device including the steps of:
providing retractable housing assembly for a payment device comprising a housing defining an internal volume, a frame connected to the housing, a carriage operatively connected to the frame, wherein the carriage is adapted to receive a payment device, wherein the carriage is in slidable engagement with the frame; and
sliding the carriage relative to the frame.

3. The retractable housing assembly of claim 1, wherein the retractable housing assembly further comprises an actuator configured to slide the carriage between a retracted position and an extended position.

4. The retractable housing assembly of claim 1, wherein the payment device is rotatable relative to the carriage.

5. The retractable housing assembly of claim 1, wherein the housing comprises a front wall.

6. The retractable housing assembly of claim 5, wherein the front wall comprises a first front wall and a second front wall.

7. The retractable housing assembly of claim 6, wherein the first front wall is actuated by a first actuator.

8. The retractable housing assembly of claim 6, wherein the second front wall is actuated by a second actuator.

9. The retractable housing assembly of claim 6, wherein a first hinge assembly connects the first front wall to the housing.

10. The retractable housing assembly of claim 6, wherein a second hinge assembly connects the second front wall to the housing.

11. The retractable housing assembly of claim 9, wherein the first hinge assembly is the same as the second hinge assembly.

12. The retractable housing assembly of claim 1, wherein the retractable housing assembly further comprises an infrared sensor.

13. The retractable housing assembly of claim 1, wherein the retractable housing assembly is formed with a structure.

14. The retractable housing assembly of claim 1, wherein the retractable housing assembly is attached to a structure that is secured to the ground.
